(19) United States
(12) Patent Application Publication
(10) Pub. No.: US 2023/0170960 A1
(43) Pub. Date: Jun. 1, 2023

(54) METHOD AND BASE STATION FOR BEAM ALIGNMENT

(71) Applicant: MEDIATEX INC., Hsin-Chu (TW)

(72) Inventor: Chien-Hwa Hwang, Hsin-Chu (TW)

(21) Appl. No.: 17/982,445

(22) Filed: Nov. 7, 2022

Related U.S. Application Data
(60) Provisional application No. 63/284,691, filed on Dec. 1, 2021.

(51) Int. Cl. H04B 7/06; H04B 7/0456

(52) U.S. Cl. CPC H04B 7/0617; H04B 7/0456; H04B 7/0665

(57) ABSTRACT

Method and BS are provided for beam alignment. In particular, a BS can determine a transmitting configuration according to a reference transmitting configuration associated with a common coordinate transformation matrix. The BS can transmit a plurality of symbols to a UE based on the transmitting configuration for the UE to derives a matrix associated with a channel matrix.

### CROSS REFERENCE TO RELATED APPLICATIONS

This application claims priority under 35 U.S.C. § 119 from U.S. Provisional Application No. 63/284,691, entitled “Compressive Sensing for Sub-THz Beam Alignment,” filed on Dec. 1, 2021, the subject matter of which is incorporated herein by reference.

### TECHNICAL FIELD

The disclosed embodiments relate generally to wireless communication, and, more particularly, to method and base station for beam alignment.

### BACKGROUND

In conventional network of 3rd generation partnership project (3GPP) 5G new radio (NR), the base station (BS) and the user equipment (UE) may respectively be equipped with antenna sub-arrays, and there may be more than one data streams transmitted from the BS to the UE via the antenna sub-arrays. However, how to perform beam alignment more accurately and efficiently between the antenna sub-arrays of the BS and the antenna sub-arrays of the UE for the data streams needs to be further discussed.

### SUMMARY

Method and base station (BS) are provided for beam alignment. In particular, a base station (BS) can determine a transmitting configuration according to a reference transmitting configuration associated with a common coordinate transformation matrix. The BS can transmit a plurality of symbols to a user equipment (UE) based on the transmitting configuration for the UE to derives a matrix associated with a channel matrix.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network supporting beam alignment in accordance with embodiments of the current invention.

FIG. 2 is a simplified block diagram of the gNB and the UE in accordance with embodiments of the current invention.

FIG. 3 illustrates one embodiment of message transmissions in accordance with embodiments of the current invention.

FIG. 4 illustrates one embodiment of message transmissions in accordance with embodiments of the current invention.

FIG. 5 is a flow chart of a method for beam alignment in accordance with embodiments of the current invention.

FIG. 6 is a flow chart of a method for beam alignment in accordance with embodiments of the current invention.

### DETAILED DESCRIPTION

Reference will now be made in detail to some embodiments of the invention, examples of which are illustrated in the accompanying drawings.

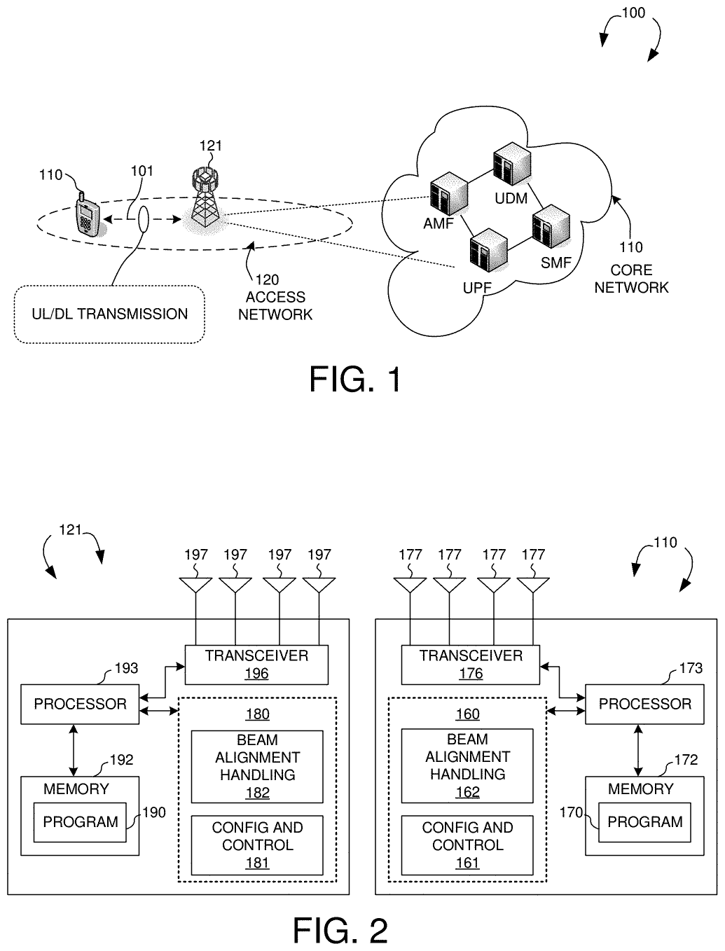

FIG. 1 illustrates an exemplary 5G new radio (NR) network 100 supporting beam alignment in accordance with aspects of the current invention. The 5G NR network 100 includes a user equipment (UE) 110 communicatively connected to a gNB 121 operating in a licensed band (e.g., 30 GHz˜300 GHz for mmWave) of an access network 120 which provides radio access using a Radio Access Technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The gNB 121 may provide communication coverage for a geographic coverage area in which communications with the UE 110 is supported via a communication link 101. The communication link 101 shown in the 5G NR network 100 may include UL transmissions from the UE 110 to the gNB 121 (e.g., on the Physical Uplink Control Channel (PUCCH) or Physical Uplink Shared Channel (PUSCH)) or downlink (DL) transmissions from the gNB 121 to the UE 110 (e.g., on the Physical Downlink Control Channel (PDCCH) or Physical Downlink Shared Channel (PDSCH)).

FIG. 2 is a simplified block diagram of the gNB 121 and the UE 110 in accordance with embodiments of the present invention. For the gNB 121, antennas 197 transmit and receive radio signal under network. The antennas 197 can be separated as antenna sub-arrays. A radio frequency (RF) transceiver module 196, coupled with the antennas, receives RF signals from the antennas, converts them to baseband signals and sends them to processor 193. RF transceiver 196 also converts received baseband signals from the processor 193, converts them to RF signals, and sends out to antennas 197. Processor 193 processes the received baseband signals and invokes different functional modules and circuits to perform features in the gNB 121. Memory 192 stores program instructions and data 190 to control the operations of the gNB 121.

Similarly, for the UE 110, antennas 177 transmit and receives RF signal under network. The antennas 177 can be separated as antenna sub-arrays. RF transceiver module 176, coupled with the antennas, receives RF signals from the antennas, converts them to baseband signals and sends them to processor 173. The RF transceiver 176 also converts received baseband signals from the processor 173, converts them to RF signals, and sends out to antennas 177. Processor 173 processes the received baseband signals and invokes different functional modules and circuits to perform features in the UE 110. Memory 172 stores program instructions and data 170 to control the operations of the UE 110.

Although a specific number of the antennas 177 and 197 are depicted in FIG. 2, it is contemplated that any number of the antennas 177 and 197 may be introduced under the network.

The gNB 121 and the UE 110 also include several functional modules and circuits that can be implemented and configured to perform embodiments of the present invention. In the example of FIG. 2, the gNB 121 includes a set of control functional modules and circuit 180. Beam alignment handling circuit 182 handles beam alignment and associated network parameters for the UE 110. Configuration and control circuit 181 provides different parameters to configure and control the UE 110. The UE 110 includes a set of control functional modules and circuit 160. Beam alignment handling circuit 162 handles beam alignment and associated network parameters. Configuration and control circuit 161 handles configuration and control parameters from the gNB 121.

Note that the different functional modules and circuits can be implemented and configured by software, firmware, hardware, and any combination thereof. The function modules and circuits, when executed by the processors 193 and 173 (e.g., via executing program codes 190 and 170), allow the gNB 121 and the UE 110 to perform embodiments of the present invention.

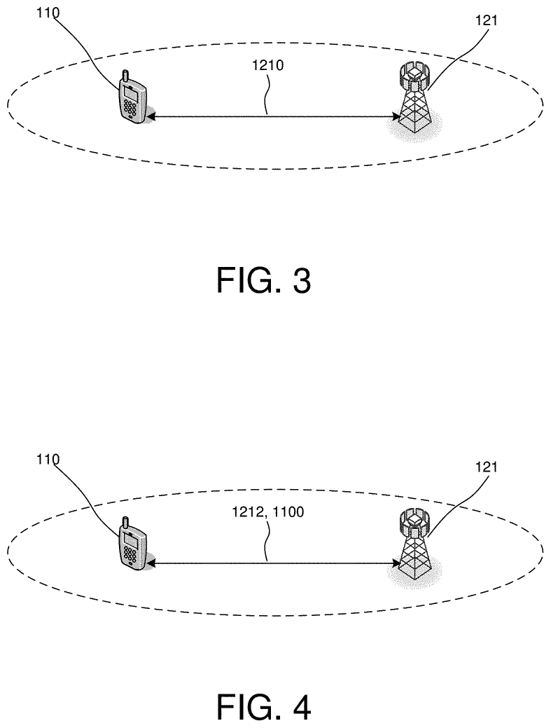

FIG. 3 illustrates one embodiment of message transmissions in accordance with one novel aspect. In particular, the gNB 121 determines a transmitting configuration according to a reference transmitting configuration. The reference transmitting configuration is a pre-configuration: (1) associated with a common coordinate transformation matrix; and (2) being default in the gNB 121 and the UE 110.

Then, the gNB 121 transmits a plurality of symbols 1210 to the UE 110 based on the transmitting configuration. Accordingly, the UE 110 derives a matrix associated with a channel matrix. The matrix associated with the channel matrix can be utilized for performing beam alignment between the gNB 121 and the UE 110.

FIG. 4 illustrates one embodiment of message transmissions in accordance with one novel aspect. In particular, the gNB 121 determines a transmitting configuration according to a reference transmitting configuration. The reference transmitting configuration is a pre-configuration: (1) associated with a common coordinate transformation matrix; and (2) being default in the gNB 121 and the UE 110.

More specifically, the common coordinate transformation matrix is A_{T} (defined in 3GPP specification) which corresponds to a pre-defined certain geometry of antenna elements for one antenna sub-array of the gNB 121. The reference transmitting configuration is A_{T}^{H}P while A_{T}^{H} is Hermitian Matrix of A_{T} and P is a reference transmitting beam book (defined in 3GPP specification) corresponding to the common coordinate transformation matrix A_{T}. P is an N̅_̅{̅T̅}̅×M_{T} matrix of [p₁, p₂, p₃ . . . p_{MT}] while N_{T} is the number of antennas of the gNB 121, N̅_̅{̅T̅}̅ is complex conjugate of N_{T} and M_{T} is the number of transmitting beams of the UE 110. The reference transmitting configuration A_{T}^{H}P is default configuration in the gNB 121 and the UE 110.

Further, the transmitting configuration is B_{T}^{H}X while B_{T} is a coordinate transformation matrix of the gNB 121, B_{T}^{H} is Hermitian Matrix of B_{T} and X is a transmitting beam book of the gNB 121. The coordinate transformation matrix B_{T} corresponds to geometry information (e.g., an actual certain geometry) of antenna elements for one antenna sub-array of the gNB 121. The transmitting beam book X corresponds to the coordinate transformation matrix B_{T}.

In some embodiments, the gNB 121 determines the transmitting configuration B_{T}^{H}X by approximating the transmitting configuration B_{T}^{H}X to the reference transmitting configuration A_{T}^{H}P. For example, the gNB 121 approximates the transmitting configuration B_{T}^{H}X to the reference transmitting configuration A_{T}^{H}P according to:

$$arg {min}_{{x}_{n}} {‖ {B}_{T}^{H} {x}_{n} - {A}_{T}^{H} {p}_{n} ‖}^{2}$$

while 1≤n≤M_{T} and X is an N̅_̅{̅T̅}̅×M_{T} matrix of [x₁, x₂, x₃ . . . x_{MT}].

Then, the gNB 121 transmits a plurality of beam alignment training symbols 1212 by an antenna sub-array. Because the transmitting configuration B_{T}^{H}X is approximated to the reference transmitting configuration A_{T}^{H}P, the UE 110 can obtain related parameters of a channel matrix H according to the reference transmitting configuration A_{T}^{H}P without knowing the transmitting configuration B_{T}^{H}X.

More specifically, according to the virtual angle domain (VAD) representation, the channel matrix H can be expressed as:

H≅H̅=B_{R}H_{ω}B_{T}^{H}

while B_{R} is a coordinate transformation matrix of the UE 110 and H̅_{ω} is a matrix associated with the channel matrix H. The matrix H̅_{ω} corresponds to complex channel gains of paths with angle of departure (AoD) and angle of arrival (AoA). The coordinate transformation matrix B_{R} corresponds to geometry information (e.g., an actual certain geometry) of antenna elements for one antenna sub-array of the UE 110.

After receiving the plurality of beam alignment training symbols 1212, the UE 110 determines measurement results Y according to the plurality of beam alignment training symbols 1212. The measurement results Y can be expressed as:

Y=\sqrt{ρ_{T}}Q^{H}HXS+Q^{H}N

while ρ_{T} is an average received power of receiving the beam alignment training symbols 1212, Q is a matrix of receiving beam book of the UE 110, Q^{H} is Hermitian Matrix of Q, X is the transmitting beam book, S is a diagonal matrix carrying the beam alignment training symbols 1212 of the M_{T} beams, and N is a noise parameter. It should be noted that, in general cases, the matrix S carrying the beam alignment training symbols 1212 can be assumed equal to an identity matrix I.

Therefore, because H≅H̅=B_{R}H̅_{ω}B_{T}^{H} and S=I, the measurement results Y can be applied by the VAD representation and expressed as:

Y=\sqrt{ρ_{T}}Q^{H}B_{R}H̅_{ω}B_{T}^{H}X+Q^{H}N

Further, because B_{T}^{H}X is approximated to the reference transmitting configuration A_{T}^{H}P, the measurement results Y can be expressed as:

Y≅\sqrt{ρ_{T}}Q^{H}B_{R}H̅_{ω}A_{T}^{H}P+Q^{H}N

Accordingly, since Y, ρ_{T}, Q, B_{R}, A_{T}^{H}P and N are known by the UE 110, the UE 110 can derive the matrix H̅_{ω} associated with the channel matrix H without knowing the parameters B_{T}^{H} and X of the transmitting configuration B_{T}^{H}X.

Then, the UE 110 transmits feedback information 1100 related to the matrix H̅_{ω} associated with the channel matrix H so that the gNB 121 identifies at least one beam pair link between the gNB 121 and the UE 110 according to the feedback information 1100.

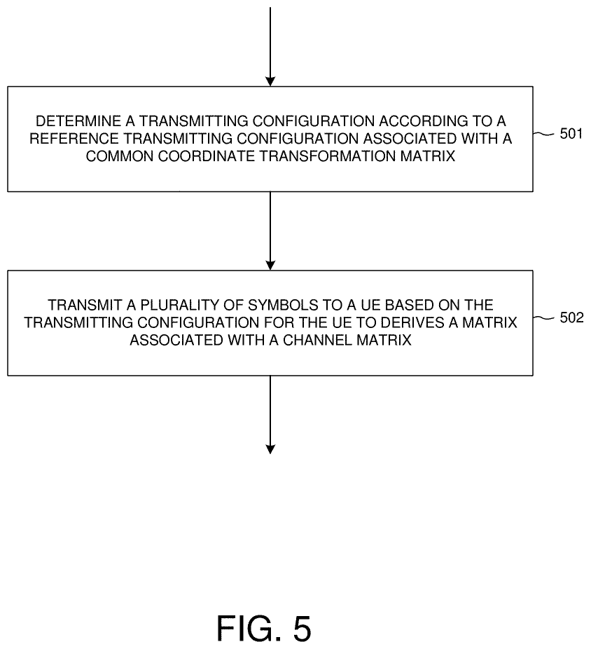

FIG. 5 is a flow chart of a method for beam alignment from BS perspective in accordance with one novel aspect. In step 501, a BS determines a transmitting configuration according to a reference transmitting configuration associated with a common coordinate transformation matrix. In step 502, the BS transmits a plurality of symbols to a UE based on the transmitting configuration for the UE to derives a matrix associated with a channel matrix.

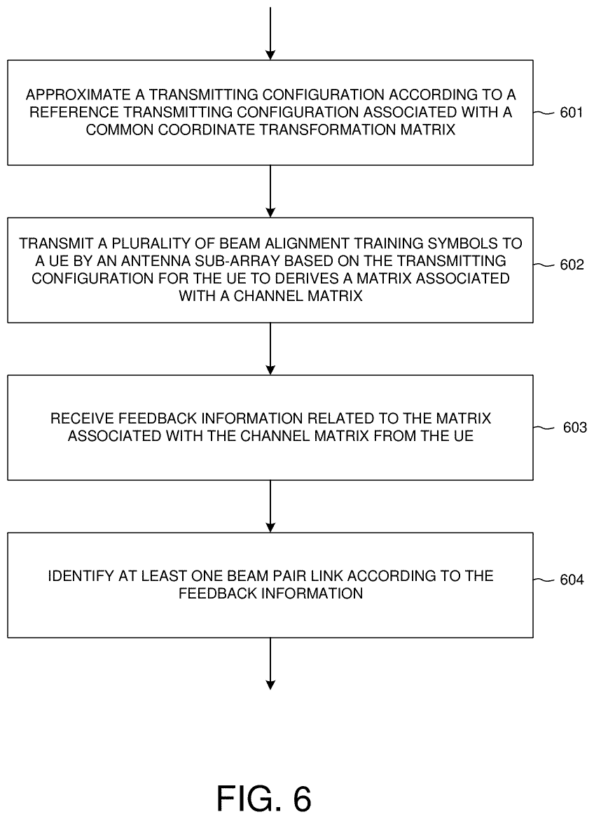

FIG. 6 is a flow chart of a method for beam alignment from BS perspective in accordance with one novel aspect. In step 601, a BS approximates a transmitting configuration according to a reference transmitting configuration associated with a common coordinate transformation matrix.

In some embodiments, the reference transmitting configuration includes A_{T}^{H}P while A_{T} includes the common coordinate transformation matrix and P includes a reference transmitting beam book. The transmitting configuration includes B_{T}^{H}X while B_{T} includes a coordinate transformation matrix, which corresponds to geometry information of antennas of the BS, of the BS and X includes a transmitting beam book of the BS.

In some embodiments, the transmitting configuration is approximated to the reference transmitting configuration according to following formula:

$$arg {min}_{{x}_{n}} {‖ {B}_{T}^{H} {x}_{n} - {A}_{T}^{H} {p}_{n} ‖}^{2} , while 1 \leq n \leq {M}_{T}$$

wherein M_{T} includes a number of transmitting beams, P includes a plurality of elements p₁ to p_{M}_{_{T}} and X includes a plurality of elements x₁ to x_{M}_{_{T}}.

In step 602, the BS transmits a plurality of beam alignment training symbols to a UE by an antenna sub-array based on the transmitting configuration for the UE to derives a matrix associated with a channel matrix according to following formula:

Y=\sqrt{ρ_{T}}Q^{H}B_{R}H̅_{ω}A_{T}^{H}P+Q^{H}N

wherein Y includes measurement results of receiving the plurality of symbols, ρ_{T} includes an average received power of receiving the symbols, Q includes a receiving beam book of the UE, B_{R} includes a coordinate transformation matrix of the UE, H̅_{ω} includes the matrix associated with the channel matrix and N includes a noise parameter.

In step 603, the BS receives feedback information related to the matrix associated with the channel matrix from the UE. In step 604, the BS identifies at least one beam pair link according to the feedback information.

In the above embodiments, the beam alignment between one transmitting sub-array of BS and one receiving sub-array of UE is discussed. The beam alignment for each possible pair between plurality of transmitting sub-arrays of BS and plurality of receiving sub-arrays of UE can be further performed based on the detail of the above embodiments.

In particular, the transmitting sub-arrays of BS can be used to transmit beam alignment training symbols in different (e.g., non-overlapping or orthogonal) radio resources over the time, frequency, code domains, etc. The radio resources used by the beam alignment training symbols of one transmit sub-array should be indicated to the receiver (i.e., UE).

When the t-th transmitting sub-array of BS is used to transmit the beam alignment training symbols, one or multiple of the receiving sub-arrays of UE is/are used to perform the beam alignment described in the above embodiments simultaneously. More specifically, to perform the beam alignment, one receiving sub-array of UE receives the beam alignment training symbols transmitted from the target transmit sub-array of BS over the indicated radio resources.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
determining, by a base station (BS), a transmitting configuration according to a reference transmitting configuration associated with a common coordinate transformation matrix; and
transmitting, by the BS, a plurality of symbols to a user equipment (UE) based on the transmitting configuration for the UE to derives a matrix associated with a channel matrix.

2. The method of claim 1, wherein the step of determining the transmitting configuration according to the reference transmitting configuration further comprises:
approximating, by the BS, the transmitting configuration to the reference transmitting configuration.

3. The method of claim 2, wherein the reference transmitting configuration includes A_{T}^{H}P while A_{T} includes the common coordinate transformation matrix and P includes a reference transmitting beam book.

4. The method of claim 3, wherein the transmitting configuration includes B_{T}^{H}X while B_{T} includes a coordinate transformation matrix of the BS and X includes a transmitting beam book of the BS.

5. The method of claim 4, wherein the transmitting configuration is approximated to the reference transmitting configuration according to following formula:
$$arg {min}_{{x}_{n}} {‖ {B}_{T}^{H} {x}_{n} - {A}_{T}^{H} {p}_{n} ‖}^{2} , while 1 \leq n \leq {M}_{T}$$
wherein M_{T} includes a number of transmitting beams, P includes a plurality of elements p₁ to p_{M}_{_{T}} and X includes a plurality of elements x₁ to x_{M}_{_{T}}.

6. The method of claim 5, wherein the step of transmitting the plurality of symbols to the UE based on the transmitting configuration further includes:
transmitting, by the BS, the plurality of symbols to the UE based on B_{T}^{H}X for the UE to derives the matrix associated with the channel matrix according to following formula:
Y=\sqrt{ρ_{T}}Q^{H}B_{R}H̅_{ω}A_{T}^{H}P+Q^{H}N
wherein Y includes measurement results of receiving the plurality of symbols, ρ_{T} includes an average received power of receiving the symbols, Q includes a receiving beam book of the UE, B_{R} includes a coordinate transformation matrix of the UE, H̅_{ω} includes the matrix associated with the channel matrix and N includes a noise parameter.

7. The method of claim 3, wherein the coordinate transformation matrix of the BS corresponds to geometry information of antennas of the BS.

8. The method of claim 1, wherein the symbols are transmitted by an antenna sub-array.

9. The method of claim 1, wherein the symbols include beam alignment training symbols.

10. The method of claim 9, further comprising:
identifying, by the BS, at least one beam pair link after transmitting the beam alignment training symbols.

11. A base station (BS) comprising:
a transceiver; and
a beam alignment handling circuit that determines a transmitting configuration according to a reference transmitting configuration associated with a common coordinate transformation;
wherein the transceiver transmits t a plurality of symbols to a user equipment (UE) based on the transmitting configuration for the UE to derives a matrix associated with a channel matrix.

12. The BS of claim 11, wherein determining the transmitting configuration according to the reference transmitting configuration further comprises:
approximating the transmitting configuration to the reference transmitting configuration.

13. The BS of claim 12, wherein the reference transmitting configuration includes A_{T}^{H}P while A_{T} includes the common coordinate transformation matrix and P includes a reference transmitting beam book.

14. The BS of claim 13, wherein the transmitting configuration includes B_{T}^{H}X while B_{T} includes a coordinate transformation matrix of the BS and X includes a transmitting beam book of the BS.

15. The BS of claim 14, wherein the transmitting configuration is approximated to the reference transmitting configuration according to following formula:
$$arg {min}_{{x}_{n}} {‖ {B}_{T}^{H} {x}_{n} - {A}_{T}^{H} {p}_{n} ‖}^{2} , while 1 \leq n \leq {M}_{T}$$
wherein M_{T} includes a number of transmitting beams, P includes a plurality of elements p₁ to p_{M}_{_{T}} and X includes a plurality of elements x₁ to x_{M}_{_{T}}.

16. The BS of claim 15, wherein transmitting the plurality of symbols to the UE based on the transmitting configuration further includes:
transmitting the plurality of symbols to the UE based on B_{T}^{H}X for the UE to derives the matrix associated with the channel matrix according to following formula:
Y=\sqrt{ρ_{T}}Q^{H}B_{R}H̅_{ω}A_{T}^{H}P+Q^{H}N
wherein Y includes measurement results of receiving the plurality of symbols, ρ_{T} includes an average received power of receiving the symbols, Q includes a receiving beam book of the UE, B_{R} includes a coordinate transformation matrix of the UE, H̅_{ω} includes the matrix associated with the channel matrix and N includes a noise parameter.

17. The BS of claim 13, wherein the coordinate transformation matrix of the BS corresponds to geometry information of antennas of the BS.

18. The BS of claim 11, wherein the symbols are transmitted by an antenna sub-array.

19. The BS of claim 11, wherein the symbols include beam alignment training symbols.

20. The BS of claim 19, wherein the beam alignment handling circuit further:
identifies at least one beam pair link after transmitting the beam alignment training symbols.
